(19) United States
(12) Patent Application Publication
(10) Pub. No.: US 2026/0217953 A1
(43) Pub. Date: Jul. 30, 2026

(54) COPOLYMER RUBBER, RUBBER COMPOSITION, AND CROSSLINKED RUBBER

(71) Applicant: ZEON CORPORATION, Tokyo (JP)

(72) Inventor: Fumiaki BANDO, Tokyo (JP)

(73) Assignee: ZEON CORPORATION, Tokyo (JP)

(21) Appl. No.: 19/144,347

(22) PCT Filed: Dec. 25, 2023
(86) PCT No.: PCT/JP2023/046463

§ 371 Date: Jun. 27, 2025

(30) Foreign Application Priority Data
Dec. 28, 2022 (JP) 2022-212458

(51) Int. Cl. C08L 9/00; C08F 236/06; C08K 3/04; C08K 5/00; C08K 5/09; C08K 5/205

(52) U.S. Cl. CPC C08L 9/00; C08F 236/06; C08K 3/04; C08K 5/0025; C08K 5/09; C08K 5/205

(57) ABSTRACT

Provided is a copolymer rubber obtained by copolymerizing a butenedioic acid diester structure-containing monomer represented by General Formula (1) below and a radical polymerizable monomer:

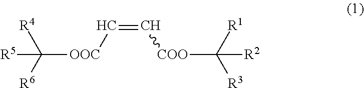

(in General Formula (1), R¹ is a C₁ to C₄ alkyl group; R² is a group represented by R⁷ or OR⁸; R⁷ is an optionally substituted C₁ to C₈ alkyl group; R³ is an optionally substituted C₁ to C₈ alkyl group or an optionally substituted polyalkylene glycol group; R³, R⁴, and R⁶ each independently represent a hydrogen atom or a C₁ to C₄ alkyl group; R⁵ is a hydrogen atom or a group represented by R³ or OR⁸; when R³ is a hydrogen atom, R² is a group represented by OR³; R¹ and R² may be bonded to each other to form a ring; and R⁴ and R⁵ may be bonded to each other to form a ring).

### TECHNICAL FIELD

The present invention relates to a copolymer rubber, a rubber composition, and a cross-linked rubber.

### BACKGROUND ART

As a method of cross-linking a copolymer rubber, typically an acrylic rubber, usually a method of heating at about 150° C. to 190° C. for several to dozen minutes as primary cross-linking, and then heating under a heated air environment at 140° C. to 200° C. as secondary cross-linking (Patent Document 1) is used.

### RELATED ART DOCUMENTS

### Patent Documents

Patent Document 1: JP 2009-084514 A

### SUMMARY OF THE INVENTION

### Problem to be Solved by the Invention

From the viewpoint of productivity of a cross-linked rubber, energy saving, and carbon neutrality, a rubber composition which can give a cross-linked rubber having good physical properties by only primary cross-linking without need for secondary cross-linking is desired.

The present invention has been made in consideration of such circumstances. An object of the present invention is to provide a copolymer rubber which has good scorch stability and can give a cross-linked rubber having sufficient mechanical properties without secondary cross-linking.

### Means for Solving Problems

The present inventor, who has conducted extensive research, has found that the above object can be achieved by a copolymer rubber obtained by copolymerizing a predetermined butenedioic acid diester structure-containing monomer and a radical polymerizable monomer, and has completed the present invention.

Specifically, the present invention provides a copolymer rubber, a rubber composition, and a cross-linked rubber described below.
[1] A copolymer rubber obtained by copolymerizing a butenedioic acid diester structure-containing monomer represented by General Formula (1) below and a radical polymerizable monomer:

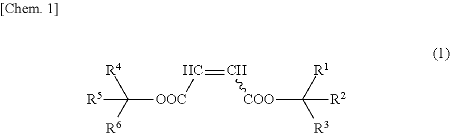

(in General Formula (1), R¹ is a C₁ to C₄ alkyl group; R² is a group represented by R⁷ or OR⁸; R⁷ is an optionally substituted C₁ to C₈ alkyl group; R³ is an optionally substituted C₁ to C₈ alkyl group or an optionally substituted polyalkylene glycol group; R³, R⁴, and R⁶ each independently represent a hydrogen atom or a C₁ to C₄ alkyl group; R⁵ is a hydrogen atom or a group represented by R³ or OR^{B}; when R³ is a hydrogen atom, R² is a group represented by OR⁸; R¹ and R² may be bonded to each other to form a ring; and R⁴ and R⁵ may be bonded to each other to form a ring).
[2] The copolymer rubber according to [1], wherein the content of a unit of the butenedioic acid diester structure-containing monomer represented by General Formula (1) is 0.1 to 10% by weight.
[3] The copolymer rubber according to [1] or [2], wherein as the radical polymerizable monomer, the copolymer rubber contains at least one selected from the group consisting of (meth)acrylic acid ester monomers, (meth) acrylonitrile monomers, aromatic vinyl monomers, conjugated diene monomers, (meth)acrylamide monomers, vinyl acetate monomer, and ethylene monomer.
[4] The copolymer rubber according to any one of [1] to [3], wherein the copolymer rubber has a glass transition temperature of 0° C. or lower.
[5] The copolymer rubber according to any one of [1] to [4], wherein the copolymer rubber contains an (meth)acrylic acid ester as the radical polymerizable monomer.
[6] The copolymer rubber according to any one of [1] to [5], wherein the copolymer rubber has a Mooney viscosity (ML1+4, 100° C.) of 10 to 150.
[7] The copolymer rubber according to any one of [1] to [6], wherein the butenedioic acid diester structure-containing monomer represented by General Formula (1) is a butenedioic acid diester structure-containing monomer represented by General Formula (2) or (3) below:

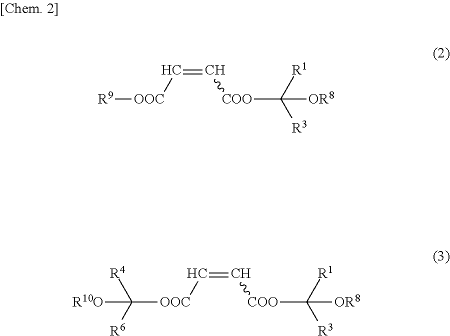

(in General Formulae (2) and (3), R¹, R³, R⁴, R⁶, and R⁸ are each independently the same as those defined in General Formula (1); R⁹ is an optionally substituted C₁ to C₁₇ alkyl group; R¹⁰ is an optionally substituted C₁ to C₈ alkyl group or an optionally substituted polyalkylene glycol group; R¹ and R⁸ may be bonded to each other to form a ring; and R⁴ and R¹⁰ may be bonded to each other to form a ring).
[8] A rubber composition comprising the copolymer rubber according to any one of [1] to [7] and a cross-linking agent.
[9] The rubber composition according to [8], further comprising a cross-linking accelerator.
[10] The rubber composition according to [8] or [9], further comprising a filler.
[11] A cross-linked rubber obtained by cross-linking the rubber composition according to any one of [8] to [10]
[12] The cross-linked rubber according to [11], wherein the cross-linked rubber is a hose material, a sealing material, a tubing material, a belt material, or a boot material.

### Effects of the Invention

The present invention can provide a copolymer rubber which has good scorch stability and can give a cross-linked rubber having sufficient mechanical properties without secondary cross-linking.

### DESCRIPTION OF EMBODIMENTS

The copolymer rubber according to the present invention is obtained by copolymerizing a butenedioic acid diester structure-containing monomer represented by General Formula (1) and a radical polymerizable monomer (which are described later).

Since the copolymer rubber according to the present invention contains a unit of the butenedioic acid diester structure-containing monomer represented by General Formula (1), such a copolymer rubber has good scorch stability and can give a cross-linked rubber having sufficient mechanical properties (specifically, sufficient tensile properties, appropriate hardness, and sufficient compression set resistance, and sufficiently suppressed change in tensile properties caused by aging) without secondary cross-linking.

### <Butenedioic Acid Diester Structure-Containing Monomer>

The butenedioic acid diester structure-containing monomer used in the present invention is represented by General Formula (1) below:

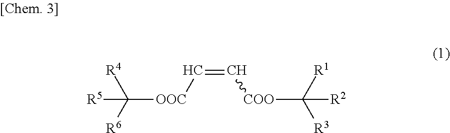

(in General Formula (1), R¹ is a C₁ to C₄ alkyl group; R² is a group represented by R⁷ or OR⁸; R⁷ is an optionally substituted C₁ to C₈ alkyl group; R³ is an optionally substituted C₁ to C₈ alkyl group or an optionally substituted polyalkylene glycol group; R³, R⁴, and R⁶ each independently represent a hydrogen atom or a C₁ to C₄ alkyl group; R⁵ is a hydrogen atom or a group represented by R³ or OR^{B}; when R³ is a hydrogen atom, R² is a group represented by OR³; R¹ and R² may be bonded to each other to form a ring; and R⁴ and R⁵ may be bonded to each other to form a ring).

The unit derived from the butenedioic acid diester structure-containing monomer represented by General Formula (1) acts as a cross-linkable monomer unit in the copolymer rubber according to the present invention. Although the mechanism of the unit acting as a cross-linkable monomer unit is not always clear, it is inferred that a carboxyl group is formed in the unit derived from the butenedioic acid diester structure-containing monomer represented by General Formula (1) during cross-linking, and acts as a cross-linking point. Since formation of the carboxyl group in the unit derived from the butenedioic acid diester structure-containing monomer represented by General Formula (1) is largely suppressed unless heating for cross-linking is performed, an unintentional increase in Mooney viscosity by cross-linking is effectively suppressed in the copolymer rubber according to the present invention. Since the copolymer rubber according to the present invention contains the unit derived from the butenedioic acid diester structure-containing monomer represented by General Formula (1) as the cross-linkable monomer unit, it has good scorch stability and can give a cross-linked rubber having sufficient mechanical properties without secondary cross-linking.

In General Formula (1), the bonding form of the group represented by —COO—C(—R¹)(—R²)(—R³) to the carbon atom may be a cis bond, or may be a trans bond. Preferred is a trans bond. Specifically, the butenedioic acid diester structure-containing monomer represented by General Formula (1) has a fumaric acid diester structure (trans bond type) or a maleic acid diester structure (cis bond type), and preferably has a fumaric acid diester structure (trans bond type).

In General Formula (1), R¹ to R⁶ may be linear, may be branched, or may have a cyclic structure.

In General Formula (1), R¹ is not particularly limited as long as it is a C₁ to C₄ alkyl group. To provide higher scorch stability and a higher cross-linking speed at the same time, preferred is a methyl group or an ethyl group, and more preferred is a methyl group. When R¹ and R² are bonded to each other to form a ring, R¹ is preferably a methylene group.

In General Formula (1), R² is a group represented by R⁷ or OR⁸. Here, R⁷ is an optionally substituted C₁ to C₈ alkyl group, and R⁸ is an optionally substituted C₁ to C₈ alkyl group or an optionally substituted polyalkylene glycol group.

Examples of the polyalkylene glycol group include a polyethylene glycol group, a polypropylene glycol group, a group composed of a copolymer chain formed by ethylene glycol and propylene glycol. In an example of the polyalkylene glycol group for R⁸, the repetition number of alkylene glycol units is preferably 1 to 3.

Examples of substituents include halogen atoms such as fluorine, chlorine, and bromine atoms; C₁ to C₁₀ alkoxy groups such as a methoxy group, an ethoxy group, and an isopropoxy group; a nitro group; a cyano group; a phenyl group, a 4-methylphenyl group, a 2-chlorophenyl group, a 1-naphthyl group, a 2-naphthyl group, and C₆ to C₁₀ aryl groups; and the like.

R² is preferably a group represented by OR³. In an example of the group represented by OR as R², to provide higher scorch stability and a higher cross-linking speed at the same time, R³ is preferably a C₁ to C₈ linear alkyl group, a C₃ to C₈ branched alkyl group, or a C₂ to C₈ linear polyalkylene glycol group, more preferably a C₁ to C₈ linear alkyl group or a C₃ to C₈ branched alkyl group, still more preferably a C₂ to C₆ linear alkyl group or a C₄ to C₈ branched alkyl group, particularly preferably an ethyl group, an n-propyl group, an isopropyl group, an n-butyl group, or a 2-ethylhexyl group.

When R¹ and R² are bonded to each other to form a ring, the ring (a ring formed by bonding two terminals of a chain represented by —R¹—C*—R²—, where C* is a carbon atom bonded to R¹, R², R³, and an oxygen atom) is preferably a 5- or 6-membered ring which may have an oxygen atom, preferably a 5- or 6-membered ring having an oxygen atom. Specific examples of such a 5-membered ring include 5-membered rings formed by bonding two terminals of a chain represented by —(CH₂) 2-C*—O—CH₂— or —(CH₂)₂—C*—(CH₂)₂—, and 5-membered rings formed by substituting one or more hydrogen atoms in these chains by a substituent such as an alkyl group. Specific examples of such a 6-membered ring include 6-membered rings formed by bonding two terminals of a chain represented by —(CH₂) 3-C*—O—CH₂— or —(CH₂)₃—C*—(CH₂)₂— and 6-membered rings formed by substituting one or more hydrogen atoms in these chains by a substituent such as an alkyl group. Among these, preferred is a ring formed by bonding two terminals of a chain represented by —(CH₂)₂-C*—O—CH₂— or —(CH₂)₃—C*—O—CH₂—.

In General Formula (1), R³ is not particularly limited as long as it is a hydrogen atom or a C₁ to C₄ alkyl group. To provide higher scorch stability and a higher cross-linking speed at the same time, R³ is preferably a hydrogen atom or a methyl group, more preferably a hydrogen atom. In General Formula (1), when R³ is a hydrogen atom, R² is a group represented by OR⁸.

In General Formula (1), R⁴ is not particularly limited as long as it is a hydrogen atom or a C₁ to C₄ alkyl group. To provide higher scorch stability and a higher cross-linking speed at the same time, R⁴ is preferably a hydrogen atom or a methyl group, more preferably a hydrogen atom. When R⁴ and R⁵ are bonded to each other to form a ring, R⁴ is preferably a methylene group.

In General Formula (1), R⁵ is a hydrogen atom or a group represented by R⁷ or OR⁸. Here, R⁷ and OR⁸ are the same as defined in R⁷ and OR as R².

To provide higher scorch stability and a higher cross-linking speed at the same time, R⁵ is preferably a group represented by R⁷, more preferably a C₁ to C₈ linear alkyl group, still more preferably a C₁ to C₄ linear alkyl group, particularly preferably a methyl group or an n-propyl group.

When R⁴ and R⁵ are bonded to each other to form a ring, the ring (a ring formed by bonding two terminals of a chain represented by —R⁴—C*—R⁵—, where C* is a carbon atom bonded to R⁴, R⁵, R⁶, and an oxygen atom) is preferably a 5- or 6-membered ring which may have an oxygen atom, preferably a 5- or 6-membered ring without having any oxygen atom. Specific examples of the ring include the above-mentioned rings formed by bonding R¹ and R² to each other. Among these, preferred is a ring formed by bonding two terminals of a chain represented by —(CH₂)₂—C*—(CH₂)₂— or —(CH₂)₃—C*—(CH₂)₂—.

In General Formula (1), R⁶ is not particularly limited as long as it is a hydrogen atom or a C₁ to C₄ alkyl group. To provide higher scorch stability and a higher cross-linking speed at the same time, R⁶ is preferably a hydrogen atom or a methyl group, more preferably a hydrogen atom.

To provide higher scorch stability and a higher cross-linking speed at the same time, the butenedioic acid diester structure-containing monomer represented by General Formula (1) is preferably a butenedioic acid diester structure-containing monomer represented by General Formula (2) or (3) below:

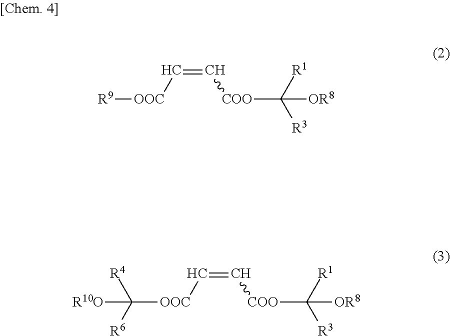

(in General Formulae (2) and (3), R¹, R³, R⁴, R⁶, and R⁸ are each independently the same as the groups defined in General Formula (1); R⁹ is an optionally substituted C₁ to C₁₇ alkyl group; R¹⁰ is an optionally substituted C₁ to C₈ alkyl group or an optionally substituted polyalkylene glycol group; R¹ and R⁸ may be bonded to each other to form a ring; and R⁴ and R¹⁰ may be bonded to each other to form a ring).

In General Formulae (2) and (3), the bonding form of the group represented by —COO—C(—R¹)(—OR⁸)(—R³) to the carbon atom may be a cis bond, or may be a trans bond. Preferred is a trans bond. In other words, the butenedioic acid diester structure-containing monomer represented by General Formula (1) includes a fumaric acid diester structure (trans bond type) or a maleic acid diester structure (cis bond type), preferably a fumaric acid diester structure (trans bond type).

In General Formulae (2) and (3), R¹, R³, R⁴, R⁶, and R⁸ to R¹⁰ may be linear, may be branched, or may have a cyclic structure.

In General Formulae (2) and (3), R¹, R³, R⁴, R⁶, and R⁸ are each independently the same as the groups defined in the General Formula (1), and the suitable groups are the same.

In General Formula (2), R⁹ is an optionally substituted C₁ to C₁₇ alkyl group, preferably an optionally substituted C₁ to C₁₆ alkyl group. Examples of substituents include those listed above. In General Formula (2), R⁹ corresponds to the group represented by —C(—R⁴)(—R⁵)(—R⁶) in General Formula (1).

To provide higher scorch stability and a higher cross-linking speed at the same time, R⁹ is preferably a C₁ to C₈ linear alkyl group or a C₃ to C₈ cycloalkyl group, more preferably a C₂ to C₆ linear alkyl group or a C₄ to C₈ cycloalkyl group, still more preferably a C₂ to C₄ linear alkyl group or a C₅ to C₇ cycloalkyl group, particularly preferably an ethyl group, an n-butyl group, or a cyclohexyl group.

In General Formula (3), R¹⁰ is an optionally substituted C₁ to C₈ alkyl group or an optionally substituted polyalkylene glycol group. Examples of substituents include those listed above. In General Formula (3), R¹⁰ is the same as R⁹ in General Formula (3).

To provide higher scorch stability and a higher cross-linking speed at the same time, R¹⁰ is preferably a C₁ to C₈ linear alkyl group, a C₃ to C₈ branched alkyl group, or a C₂ to C₈ linear polyalkylene glycol group, preferably a C₁ to C₈ linear alkyl group or a C₃ to C₈ branched alkyl group, still more preferably a C₂ to C₆ linear alkyl group or a C₄ to C₈ branched alkyl group, particularly preferably an ethyl group, an n-propyl group, an isopropyl group, an n-butyl group, or a 2-ethylhexyl group. When R⁴ and R¹⁰ are bonded to each other to form a ring, the ring (a ring formed by bonding two terminals of a chain represented by —R⁴—C*—OR⁰—, where C* is a carbon atom bonded to R⁴, OR¹⁰, R⁶, and an oxygen atom) is preferably a 5- or 6-membered ring which may have an oxygen atom, preferably a 5- or 6-membered ring having an oxygen atom. Specific examples of the ring include the above-mentioned rings formed by bonding R¹ and R² to each other. Among these, preferred is a ring formed by bonding two terminals of a chain represented by —(CH₂)₂—C*—O—CH₂— or —(CH₂)₃—C*—O—CH₂—.

The butenedioic acid diester structure-containing monomer represented by General Formula (1) can be produced by any method without limitation, and conventionally known methods can be used in combination appropriately. For example, the butenedioic acid diester structure-containing monomer represented by General Formula (1) can be produced by reacting a butenedioic acid monoester represented by R⁴R⁵R⁶COOCHC═CHCOOH with an unsaturated compound represented by R¹—CR²R³ (where R¹ is a group which forms R after the reaction).

The content of the unit of the butenedioic acid diester structure-containing monomer represented by General Formula (1) in the copolymer rubber according to the present invention is preferably 0.1 to 10% by weight, more preferably 0.5 to 7% by weight, still more preferably 1 to 5% by weight. When the content of the unit of the butenedioic acid diester structure-containing monomer represented by General Formula (1) falls within these ranges above, higher scorch stability and a higher cross-linking speed can be provided at the same time.

### <Radical Polymerizable Monomer>

The radical polymerizable monomer can be any radical polymerizable monomer as long as it is a monomer which has radical polymerizability and is copolymerizable with the above-mentioned butenedioic acid diester structure-containing monomer represented by General Formula (1). Examples thereof include (meth)acrylic acid ester monomers [meaning acrylic acid ester monomer and/or methacrylic acid ester monomer. Hereinafter, the same is applied to methyl (meth)acrylate and the like.], (meth)acrylonitrile monomers, aromatic vinyl monomers, conjugated diene monomers, (meth)acrylamide monomers, vinyl acetate monomer, ethylene monomer, and the like.

The radical polymerizable monomer preferably contains at least one selected from the group consisting of (meth)acrylic acid ester monomers, (meth) acrylonitrile monomers, aromatic vinyl monomers, conjugated diene monomers, (meth)acrylamide monomers, vinyl acetate monomer, and ethylene monomer, and more preferably contains an (meth)acrylic acid ester monomer.

The copolymer rubber according to the present invention may be an acrylic rubber containing an (meth)acrylic acid ester monomer unit; a nitrile rubber containing an (meth)acrylonitrile monomer unit; a styrene-butadiene rubber containing a styrene unit as an aromatic vinyl monomer unit and a butadiene unit as a conjugated diene monomer; and a conjugated diene rubber containing a conjugated diene monomer unit; or the like. Among these, the copolymer rubber according to the present invention is preferably an acrylic rubber containing an (meth)acrylic acid ester monomer unit.

When the copolymer rubber according to the present invention is an acrylic rubber containing an (meth)acrylic acid ester monomer unit, examples of (meth)acrylic acid ester monomers for forming an (meth)acrylic acid ester monomer unit include, but should not be limited to, alkyl (meth)acrylate ester monomers, alkoxyalkyl (meth)acrylate ester monomers, and the like.

The alkyl (meth)acrylate ester monomer is not particularly limited, and is preferably an ester of a C₁ to C₈ alkanol with (meth)acrylic acid. Specifically, examples thereof include methyl (meth)acrylate, ethyl (meth)acrylate, n-propyl (meth)acrylate, isopropyl (meth)acrylate, n-butyl (meth)acrylate, isobutyl (meth)acrylate, n-hexyl (meth)acrylate, 2-ethylhexyl (meth)acrylate, cyclohexyl (meth)acrylate, and the like. Among these, methyl (meth)acrylate, ethyl (meth)acrylate, and n-butyl (meth)acrylate are preferred, and ethyl acrylate and n-butyl acrylate are particularly preferred. These can be used alone or in combination.

In one embodiment, the copolymer rubber according to the present invention may contain both an ethyl acrylate unit and an n-butyl acrylate unit as the (meth)acrylic acid ester monomer unit. In this case, the weight ratio of the contents of these two monomer units [content of ethyl acrylate unit:content of n-butyl acrylate unit] is preferably 1:99 to 99:1, more preferably 5:95 to 90:10, still more preferably 10:90 to 80:20.

The alkoxyalkyl (meth)acrylate ester monomer is not particularly limited, and is more preferably an ester of a C₂ to C₁₂ alkoxyalkyl alcohol with (meth)acrylic acid, more preferably an ester of a C₂ to C₈ alkoxyalkyl alcohol with (meth)acrylic acid. Specifically, examples thereof include methoxymethyl (meth)acrylate, ethoxymethyl (meth)acrylate, 2-methoxyethyl (meth)acrylate, 2-ethoxyethyl (meth)acrylate, 2-propoxyethyl (meth)acrylate, 2-butoxyethyl (meth)acrylate, 3-methoxypropyl (meth)acrylate, 4-methoxybutyl (meth)acrylate, and the like. Among these, 2-ethoxyethyl (meth)acrylate and 2-methoxyethyl (meth)acrylate are preferred, and 2-ethoxyethyl acrylate and 2-methoxyethyl acrylate are particularly preferred. These can be used alone or in combination.

When the copolymer rubber according to the present invention is an acrylic rubber, the content of the (meth)acrylic acid ester monomer unit in the total monomer units is preferably 50 to 99.9% by weight, more preferably 70 to 99.5% by weight, still more preferably 90 to 99.5% by weight, particularly preferably 93 to 99.5% by weight, most preferably 95 to 99% by weight. When the content of the (meth)acrylic acid ester monomer unit falls within these ranges above, a cross-linked rubber having higher mechanical properties can be obtained.

When the copolymer rubber according to the present invention is an acrylic rubber, the weight ratio of the content of the alkyl (meth)acrylate ester monomer unit to that of the alkoxyalkyl (meth)acrylate ester monomer unit [content of alkyl (meth)acrylate ester monomer unit:content of alkoxyalkyl (meth)acrylate ester monomer unit] is preferably 10:90 to 100:0, more preferably 20:80 to 100:0.

When the copolymer rubber according to the present invention is an acrylic rubber, the copolymer rubber according to the present invention may be the one prepared by copolymerizing the butenedioic acid diester structure-containing monomer represented by General Formula (1) and the (meth)acrylic acid ester monomer with an additional monomer copolymerizable therewith. Examples of such a copolymerizable additional monomer include ester monomers other than the butenedioic acid diester structure-containing monomer represented by General Formula (1), conjugated diene monomers, non-conjugated diene monomers, aromatic vinyl monomers, α,β-ethylenically unsaturated nitrile monomers such as (meth)acrylonitrile monomers, acrylamide monomers such as (meth)acrylamide monomers, other olefin monomers, and the like.

Examples of the ester monomers other than the butenedioic acid diester structure-containing monomer represented by General Formula (1) include α,β-ethylenically unsaturated monocarboxylic acid esters, α,β-ethylenically unsaturated dicarboxylic acid diesters other than the butenedioic acid diester structure-containing monomer represented by General Formula (1), and the like. The ester monomers other than the butenedioic acid diester structure-containing monomer represented by General Formula (1) are usually non-cross-linkable monomers.

Examples of the conjugated diene monomers include 1,3-butadiene, isoprene, piperylene, and the like. Examples of the non-conjugated diene monomers include ethylidene norbornene, dicyclopentadiene, dicyclopentadienyl (meth)acrylate, 2-dicyclopentadienylethyl (meth)acrylate, and the like.

Examples of the aromatic vinyl monomers include styrene, α-methylstyrene, divinylbenzene, and the like.

Examples of the α,β-ethylenically unsaturated nitrile monomers include acrylonitrile, methacrylonitrile, and the like.

Examples of the acrylamide monomers include acrylamide, methacrylamide, and the like.

Examples of the other olefin monomers include, ethylene, propylene, vinyl chloride, vinylidene chloride, vinyl acetate, ethyl vinyl ether, butyl vinyl ether, and the like.

These copolymerizable additional monomers can be used alone or in combination. The content of the unit of the copolymerizable additional monomer in the monomer units contained in the copolymer rubber according to the present invention is preferably 0 to 30% by weight, more preferably 0 to 20% by weight, still more preferably 0 to 10% by weight.

Examples of the copolymerizable additional monomers also include carboxyl group-containing monomers. Examples of the carboxyl group-containing monomers include α,β-ethylenically unsaturated dicarboxylic acid monoester monomers, α,β-ethylenically unsaturated monocarboxylic acids, α,β-ethylenically unsaturated dicarboxylic acids, and the like.

The content of the carboxyl group-containing monomer unit in the total monomer units contained in the copolymer rubber according to the present invention is preferably 0 to 1% by weight, more preferably 0 to 0.5% by weight, still more preferably 0 to 0.2% by weight, particularly preferably 0 to 0.1% by weight. When the content of the carboxyl group-containing monomer unit falls within these ranges above, higher scorch stability and a higher cross-linking speed can be provided at the same time.

The weight average molecular weight (Mw) of the copolymer rubber according to the present invention is preferably 50,000 to 5,000,000, more preferably 100,000 to 4,000,000, still more preferably 150,000 to 3,500,000, although not particularly limited thereto. The weight average molecular weight of the acrylic rubber can be determined as a value against polystyrene standards by gel permeation chromatography.

The copolymer rubber according to the present invention has a polymer Mooney viscosity (ML1+4, 100° C.) of preferably 10 to 150, more preferably 15 to 80, still more preferably 20 to 70.

The copolymer rubber according to the present invention has a glass transition temperature of preferably 0° C. or lower, more preferably −70 to −5° C., still more preferably −50 to −15° C.

### <Method of Producing Copolymer Rubber>

The copolymer rubber according to the present invention can be obtained by polymerizing the above-mentioned monomers. As a type of the polymerization reaction, any method of emulsion polymerization, suspension polymerization, bulk polymerization, and solution polymerization can be used. From the viewpoint of ease in control of the polymerization reaction, emulsion polymerization is preferred. Specifically, the method of producing the copolymer rubber according to the present invention is suitably a method of emulsion polymerizing monomer components including the butenedioic acid diester structure-containing monomer represented by General Formula (1) and a radical polymerizable monomer component in the presence of a polymerization catalyst.

Examples of the monomer components used in emulsion polymerization include the above-mentioned monomers, and the suitable monomers are as described above. The amounts of the monomers used can be appropriately selected within the above ranges specified for the composition.

Examples of emulsifiers include, but should not be limited to, nonionic emulsifiers, anionic emulsifiers, cationic emulsifiers, and the like.

Examples of nonionic emulsifiers include, but should not be limited to, polyoxyalkylene fatty acid esters such as polyoxyethylene stearic acid esters and polyoxyethylene sorbitan alkyl esters; polyoxyalkylene alkyl ethers such as polyoxyethylene dodecyl ether; polyoxyalkylene alkylphenyl ethers such as polyoxyethylene nonylphenyl ether; and the like. Among these, polyoxyalkylene alkyl ethers and polyoxyalkylene alkylphenyl ethers are preferred, and polyoxyethylene alkyl ethers and polyoxyethylene alkylphenyl ethers are more preferred. The weight average molecular weight of the nonionic emulsifier (weight average molecular weight determined against polystyrene standards in measurement by gel permeation chromatography (GPC)) is in the range of usually 300 to 50,000, preferably 500 to 30,000, more preferably 1,000 to 15,000, although not particularly limited thereto. These nonionic emulsifiers can be used alone or in combination.

Examples of anionic emulsifiers include, but should not be limited to, salts of fatty acids such as myristic acid, palmitic acid, oleic acid, and linolenic acid; alkylbenzene sulfonates such as sodium dodecylbenzenesulfonate; higher alcohol sulfate ester salts such as sodium lauryl sulfate, phosphate ester salts such as sodium alkyl phosphate ester, preferably higher alcohol phosphate ester salts such as sodium phosphate esters with an alcohol having a hydrophobic group with 6 or more carbon atoms; alkyl sulfosuccinate salts; and the like. Among these anionic emulsifiers, preferred are phosphate ester salts and higher alcohol sulfate ester salts, more preferred are higher alcohol phosphate ester salts and higher alcohol sulfate ester salts, and still more preferred are higher alcohol phosphate ester salts. These anionic emulsifiers can be used alone or in combination.

Examples of cationic emulsifiers include alkyltrimethylammonium chloride, dialkylammonium chloride, benzylammonium chloride, and the like.

These emulsifiers can be used alone or in combination. Among these, nonionic emulsifiers and anionic emulsifiers are preferred, and anionic emulsifiers are more preferred.

The total amount of the emulsifier used is in the range of usually 0.01 to 10 parts by weight, preferably 0.1 to 5 parts by weight, more preferably 1 to 3 parts by weight relative to 100 parts by weight of the monomer components used in the polymerization.

The method of emulsifying monomer components used in polymerization (including the butenedioic acid diester structure-containing monomer represented by General Formula (1) and the radical polymerizable monomer) using water and an emulsifier is not particularly limited. Preferred is a method of mixing the monomer components with water and an emulsifier, and more preferred is a method of stirring the monomer components with water and an emulsifier using a stirrer such as a homogenizer or a disk turbine. The monomer emulsion solution may contain polymerization auxiliary materials such as a particle size adjuster, a chelating agent, and an oxygen scavenger, as needed.

The polymerization initiator is not particularly limited, and those usually used in emulsion polymerization can be used without limitation. For example, as the polymerization initiator, a peroxide, an azo compound, or a redox polymerization initiator composed of a peroxide and a reductant is preferably used.

The peroxide used can be either an inorganic peroxide or an organic peroxide.

Examples of the inorganic peroxide include sodium persulfate, potassium persulfate, hydrogen peroxide, ammonium persulfate, and the like. Among these, potassium persulfate, hydrogen peroxide, and ammonium persulfate are preferred, and potassium persulfate is particularly preferred.

Examples of the organic peroxide include 2,2-di(4,4-di-(t-butylperoxy)cyclohexyl)propane, 1-di-(t-hexylperoxy)cyclohexane, 1,1-di-(t-butylperoxy)cyclohexane, n-butyl 4,4-di-(t-butylperoxy) valerate, 2,2-di-(t-butylperoxy)butane, t-butyl hydroperoxide, cumene hydroperoxide, diisopropylbenzene hydroperoxide, paramenthane hydroperoxide, benzoyl peroxide, 1,1,3,3-tetramethylbutyl hydroperoxide, t-butylcumyl peroxide, di-t-butyl peroxide, di-t-hexyl peroxide, di(2-t-butylperoxyisopropyl)benzene, dicumyl peroxide, diisobutyryl peroxide, di(3,5,5-trimethylhexanoyl)peroxide, dilauroyl peroxide, disuccinic peroxide, dibenzoyl peroxide, di(3-methylbenzoyl) peroxide, benzoyl (3-methylbenzoyl) peroxide, diisobutyryl peroxydicarbonate, di-n-propyl peroxydicarbonate, di(2-ethylhexyl) peroxydicarbonate, di-sec-butyl peroxydicarbonate, 1,1,3,3-tetramethylbutyl peroxyneodecanoate, t-hexyl peroxypivalate, t-butyl peroxyneodecanoate, t-hexyl peroxypivalate, t-butyl peroxypivalate, 2,5-dimethyl-2,5-di(2-ethylhexanoylperoxy) hexane, 1,1,3,3-tetramethylbutyl peroxy-2-ethylhexanoate, t-hexyl peroxy-2-ethylhexanoate, t-butyl peroxy-3,5,5-trimethylhexanoate, t-hexyl peroxyisopropylmonocarbonate, t-butyl peroxyisopropylmonocarbonate, t-butyl peroxy-2-ethylhexyl monocarbonate, 2,5-dimethyl-2,5-di(benzoylperoxy) hexane, t-butyl peroxyacetate, t-hexyl peroxybenzoate, t-butyl peroxybenzoate, 2,5-dimethyl-2,5-di(t-butylperoxy) hexane, and the like. Among these, diisopropylbenzene hydroperoxide, cumene hydroperoxide, paramenthane hydroperoxide, and benzoyl peroxide are preferred.

Examples of the azo compound include azobisisobutyronitrile, 4,4′-azobis(4-cyanovaleric acid), 2,2′-azobis[2-(2-inidazolin-2-yl) propane, 2,2′-azobis(propane-2-carboxamidine), 2,2′-azobis[N-(2-carboxyethyl)-2-methylpropanamide], 2,2′-azobis{2-[1-(2-hydroxyethyl)-2-imidazolin-2-yl]propane}, 2,2′-azobis(1-imino-1-pyrrolidino-2-methylpropane), 2,2′-azobis{2-methyl-N-[1,1-bis(hydroxymethyl)-2-hydroxyethyl]propanamide}, and the like.

These peroxides and azo compounds can be used alone or in combination. The amounts of the peroxide and azo compound used in the initial polymerization step are preferably 0.001 to 0.5 parts by weight, more preferably 0.002 to 0.4 parts by weight, still more preferably 0.003 to 0.3 parts by weight relative to 100 parts by weight of the monomer components used in the polymerization.

The reductant used in combination with the peroxide can be any reactant which is used as a redox catalyst for emulsion polymerization. As the reductant, use of at least two reductants is preferred. Among these, suitable is a combination of an ionic compound of a reduced metal with a reductant other than this.

Examples of such an ionic compound of a reduced metal include, but should not be limited to, ferrous sulfate, ferric sodium hexamethylenediaminetetraacetate, cuprous naphthenate, and the like. Among these, ferrous sulfate is preferred.

These ionic compounds of a reduced metal can be used alone or in combination. The amount of the ionic compound of a reduced metal used in the initial polymerization step is preferably 0.0005 to 0.0030 parts by weight, more preferably 0.0007 to 0.0025 parts by weight, still more preferably 0.0010 to 0.0020 parts by weight relative to 100 parts by weight of the monomer components used in the polymerization.

Examples of reductants other than the ionic compound of a reduced metal include, but should not be limited to, ascorbic acid and salts thereof such as ascorbic acid, sodium ascorbate, and potassium ascorbate; erythorbic acid and salts thereof such as erythorbic acid, sodium erythorbate, and potassium erythorbate; sulfinic acid salts such as formaldehyde sodium sulfoxylate; sulfurous acid salts such as sodium sulfite, potassium sulfite, sodium hydrogen sulfite, aldehyde sodium hydrogen sulfite, and potassium hydrogen sulfite; pyrosulfates such as sodium pyrosulfite, potassium pyrosulfite, sodium hydrogen pyrosulfite, and potassium hydrogen pyrosulfite; thiosulfates such as sodium thiosulfate and potassium thiosulfate; phosphorous acid and salts thereof such as phosphorous acid, sodium phosphite, potassium phosphite, sodium hydrogen phosphite, and potassium hydrogen phosphite; pyrophosphorus acid and salts thereof such as pyrophosphorus acid, sodium pyrophosphite, potassium pyrophosphite, sodium hydrogen pyrophosphite, and potassium hydrogen pyrophosphite; and the like. Among these, ascorbic acid and salts thereof and formaldehyde sodium sulfoxylate are preferred.

These reductants other than the ionic compound of a reduced metal can be used alone or in combination. The amount of the reductant other than the ionic compound of a reduced metal used in the initial polymerization step is preferably 0.005 to 0.080 parts by weight, more preferably 0.010 to 0.060 parts by weight, still more preferably 0.020 to 0.040 parts by weight relative to 100 parts by weight of the monomer components used in the polymerization.

Examples of a preferred combination of the ionic compound of a reduced metal with the reductant other than the ionic compound of a reduced metal include a combination of ferrous sulfate with ascorbic acid or a salt thereof and/or formaldehyde sodium sulfoxylate. More preferred is a combination of ferrous sulfate with a salt of ascorbic acid and/or formaldehyde sodium sulfoxylate. Particularly preferred is a combination of ferrous sulfate with formaldehyde sodium sulfoxylate.

The amount of water used in emulsion polymerization is preferably 5 to 500 parts by weight, more preferably 10 to 300 parts by weight, still more preferably 20 to 200 parts by weight relative to 100 parts by weight of the monomer components used in the polymerization.

In emulsion polymerization, polymerization auxiliary materials such as a molecular weight modifier, a particle size adjuster, a chelating, and an oxygen scavenger can be used as needed.

Emulsion polymerization can be performed by any one of a batchwise method, a semi-batchwise method, and a continuous method. Preferred is a semi-batchwise method.

The polymerization temperature and the polymerization time are not particularly limited, and can be appropriately selected according to the type of the polymerization catalyst used or the like. The polymerization temperature is preferably 0 to 100° C., more preferably 5 to 80° C., still more preferably 10 to 50° C. The polymerization time is preferably 0.5 to 100 hours, more preferably 1 to 10 hours. The polymerization conversion ratio is preferably 80% by weight or more, more preferably 90% by weight or more, still more preferably 95% by weight or more, although not particularly limited thereto.

When the polymerization reaction is terminated, a polymerization terminator can be used. Examples of the polymerization terminator include hydroxylamine, hydroxyamine sulfuric acid salt, diethylhydroxyamine, hydroxyamine sulfonic acid and alkali metal salts thereof, sodium dimethyldithiocarbamate, hydroquinone, and the like. The amount of the polymerization terminator used is preferably 0.1 to 2 parts by weight relative to 100 parts by weight of the monomer components used in the polymerization, although not particularly limited thereto.

In the next step, solidification is performed by bringing a solidifying agent into contact with the resulting polymer emulsion, generating hydrous crumbs.

Examples of the solidifying agent include, but should not be limited thereto, mono- to trivalent metal salts. A mono- to trivalent metal salt indicates a salt containing a metal which becomes a mono- to trivalent metal ion when the salt is dissolved in water. Examples thereof include, but should not be limited to, salts of an inorganic acid selected from hydrochloric acid, nitric acid, sulfuric acid, and the like or an organic acid such as acetic acid with a metal selected from sodium, potassium, lithium, magnesium, calcium, zinc, titanium, manganese, iron, cobalt, nickel, aluminum, tin, and the like. Hydroxides of these metals can also be used.

Specific examples of the mono- to trivalent metal salt include metal chlorides such as sodium chloride, potassium chloride, lithium chloride, magnesium chloride, calcium chloride, zinc chloride, titanium chloride, manganese chloride, iron chloride, cobalt chloride, nickel chloride, aluminum chloride, and tin chloride; nitric acid salts such as sodium nitrate, potassium nitrate, lithium nitrate, magnesium nitrate, calcium nitrate, zinc nitrate, titanium nitrate, manganese nitrate, iron nitrate, cobalt nitrate, nickel nitrate, aluminum nitrate, and tin nitrate; sulfuric acid salts such as sodium sulfate, potassium sulfate, lithium sulfate, magnesium sulfate, calcium sulfate, zinc sulfate, titanium sulfate, manganese sulfate, iron sulfate, cobalt sulfate, nickel sulfate, aluminum sulfate, and tin sulfates; and the like. Among these, preferred are calcium chloride, sodium chloride, aluminum sulfate, magnesium chloride, magnesium sulfate, zinc chloride, zinc sulfate, and sodium sulfate. Among these, preferred are mono- or divalent metal salts, more preferred are divalent metal salts, more preferred are magnesium salts, still more preferred are inorganic magnesium salts, and particularly preferred is magnesium sulfate. These can be used alone or in combination.

The amount of the solidifying agent used is preferably 0.01 to 100 parts by weight, more preferably 0.1 to 50 parts by weight, still more preferably 1 to 30 parts by weight relative to 100 parts by weight of the monomer components used in the polymerization. When the amount of the solidifying agent used falls within these ranges above, the copolymer rubber can be sufficiently solidified, and the resulting copolymer rubber can have high moisture resistance.

Examples of the method of bringing the polymer emulsion into contact with the solidifying agent include, but should not be limited to, a method of adding the polymer emulsion to an aqueous solution containing a solidifying agent while stirring the aqueous solution containing a solidifying agent, a method of adding an aqueous solution containing a solidifying agent to the polymer emulsion while stirring the polymer emulsion, and the like. Alternatively, a method of simply adding an aqueous solution containing a solidifying agent to the polymer emulsion without stirring, or a method of simply adding an aqueous solution containing a solidifying agent to the polymer emulsion may be used. Among these, preferred is a method of adding the polymer emulsion to an aqueous solution containing a solidifying agent while stirring the aqueous solution containing a solidifying agent. By performing a solidification operation using such a method, the particle size of the hydrous crumbs formed by solidification can be controlled to a relatively uniform range, and thus, the hydrous crumbs can be formed with higher washing efficiency.

The concentration of the magnesium salt in the aqueous solution containing a solidifying agent is not particularly limited. To more suitably control the particle size of the hydrous crumbs formed by solidification, the concentration is preferably 0.1 to 20% by weight, more preferably 0.5 to 10% by weight, still more preferably 1 to 5% by weight.

The temperature (i.e., solidification temperature) of the aqueous solution containing a solidifying agent is not particularly limited. To more suitably control the particle size of the hydrous crumbs formed by solidification, the temperature is preferably 40° C. or higher, more preferably 40 to 90° C., still more preferably 50 to 85° C.

Examples of the stirring method when the aqueous solution containing a solidifying agent is stirred include, but should not be limited to, a method using a stirrer which performs stirring with a stirring blade. In this case, preferred is use of a method of placing an aqueous solution containing a solidifying agent into a stirring tank, and adding the polymer emulsion while stirring the aqueous solution containing a solidifying agent with the stirring blade.

Furthermore, the solid concentration of the polymer emulsion used in the solidification is not particularly limited, and the polymer emulsion obtained by emulsion polymerization may be used as it is. To more suitably control the particle size of the hydrous crumbs formed by solidification, the solid concentration is adjusted to the range of preferably 5 to 50% by weight, more preferably 10 to 45% by weight, particularly preferably 20 to 40% by weight.

In the next step, preferably, the hydrous crumbs formed through the solidification operation are washed. Examples of the washing method include, but should not be limited to, a method of washing the hydrous crumbs formed through the solidification operation with water, suitably a method of mixing the hydrous crumbs formed through the solidification operation with water, and the like. The temperature for washing with water is not particularly limited, but is preferably 5 to 60° C., more preferably 10 to 50° C. The mixing time is 1 to 60 minutes, more preferably 2 to 30 minutes.

The amount of water mixed with the hydrous crumbs during the washing with water is not particularly limited. To further increase efficiency in washing with water, water is mixed in an amount of preferably 50 parts by weight or more, more preferably 50 to 15,000 parts by weight, still more preferably 100 to 10,000 parts by weight, particularly preferably 500 to 5000 parts by weight relative to 100 parts by weight of the monomer components used in the polymerization.

The time for washing with water is not particularly limited, and is preferably 1 to 120 minutes, more preferably 2 to 60 minutes, still more preferably 3 to 30 minutes.

Washing with water can be performed any times, and the number of times is preferably 1 to 10 times, more preferably 1 to 5 times, still more preferably 1 to 3 times. In the present invention, the number of times of washing with water indicates the number of times of an operation to add water to the hydrous crumbs to mix these for a predetermined time, and then separate the hydrous crumbs from the water used in washing with water, where the operation is regarded as one operation of washing with water. Specifically, for example, two times of washing with water means that the operation to add water to the hydrous crumbs to mix these for a predetermined time, and then separate the hydrous crumbs from the water used in washing with water is performed, and subsequently, the operation to add water to the hydrous crumbs to mix these for a predetermined time, and then separate the hydrous crumbs from the water used in washing with water is further performed. When washing with water is performed two or more times, the temperature and amount of water used in washing with water and the time for washing with water may be the same, or may be different.

In the present invention, after washing with water is performed, acid washing using an acid as a washing liquid may be further performed. After acid washing is performed, preferably, washing with water is further performed. The washing with water can be performed under the same conditions as those described above.

The hydrous crumbs subjected to washing may be dried. The method of drying the hydrous crumbs is not particularly limited, and it is sufficient that the method conforms to an ordinary method. Examples thereof include a method of drying using a dryer such as a hot air dryer, a reduced pressure dryer, an expander dryer, a kneader-type dryer, or a screw extruder.

The hydrous crumb drying temperature is preferably 80 to 250° C., more preferably 100 to 200° C., still more preferably 110 to 180° C., although not particularly limited thereto.

The copolymer rubber according to the present invention can be produced as described above, for example. In the present invention, the copolymer rubber may be obtained in the state of crumbs, or may be obtained as bale-shaped rubber, that is, rubber bales (copolymer rubber in the form of blocks having a predetermined shape).

### <Rubber Composition>

The rubber composition according to the present invention comprises the above-mentioned copolymer rubber according to the present invention and a cross-linking agent.

The cross-linking agent is not particularly limited, and conventionally known cross-linking agents can be used, including polyvalent amine compounds, such as diamine compounds and carbonates thereof; sulfur; sulfur donors; triazinethiol compounds; polyvalent epoxy compounds; organic carboxylate ammonium salts; organic peroxides; metal salts of dithiocarbamic acid; polyvalent carboxylic acids; quaternary onium salts; imidazole compounds; isocyanuric acid compounds; and the like. These cross-linking agents can be used alone or in combination.

The polyvalent amine compounds and carbonates thereof are not particularly limited. Preferred are C₄ to Cao polyvalent amine compounds and carbonates thereof. Examples of such polyvalent amine compounds and carbonates thereof include aliphatic polyvalent amine compounds and carbonates thereof, aromatic polyamine compounds, and the like.

Examples of the aliphatic polyvalent amine compounds and carbonates thereof include, but should not be limited to, hexamethylenediamine, hexamethylenediamine carbamate, N,N′-dicinnamylidene-1,6-hexanediamine, and the like.

Examples of the aromatic polyamine compounds include, but should not be limited to, 4,4′-methylenedianiline, p-phenylenediamine, m-phenylenediamine, 4,4′-diaminodiphenyl ether, 3,4′-diaminodiphenyl ether, 4,4′-(m-phenylenediisopropylidene)dianiline, 4,4′-(p-phenylenediisopropylidene)dianiline, 2,2-bis[4-(4-aminophenoxy)phenyl]propane, 4,4′-diaminobenzanilide, 4,4′-bis(4-aminophenoxy)biphenyl, m-xylylenediamine, p-xylylenediamine, 1,3,5-benzenetriamine, and the like. Among these, 2,2′-bis[4-(4-aminophenoxy)phenyl]propane is preferred.

Among these cross-linking agents, polyvalent amine compounds and carbonates thereof are preferred, aliphatic polyvalent amine compounds and carbonates thereof are more preferred, and hexamethylenediamine carbamate is still more preferred because higher scorch stability and a higher cross-linking speed can be provided at the same time and a cross-linked rubber having further enhanced mechanical properties can be obtained.

The content of the cross-linking agent in the rubber composition according to the present invention is preferably 0.1 to 10 parts by weight, more preferably 0.2 to 5 parts by weight relative to 100 parts by weight of the copolymer rubber according to the present invention. When the content of the cross-linking agent falls within these ranges above, higher scorch stability and a higher cross-linking speed can be provided at the same time and a cross-linked rubber having further enhanced mechanical properties can be obtained.

The rubber composition according to the present invention may contain a rubber other than the above-mentioned copolymer rubber according to the present invention. Examples of the rubber other than the copolymer rubber according to the present invention include, but should not be limited to, rubbers not containing the unit of the butenedioic acid diester structure-containing monomer represented by General Formula (1)(such as acrylic rubber, natural rubber, polybutadiene rubber, polyisoprene rubber, styrene-butadiene rubber, acrylonitrile-butadiene rubber, silicon rubber, fluorocarbon rubber, olefin elastomer, styrene elastomer, vinyl chloride elastomer, polyester elastomer, polyamide elastomer, polyurethane elastomer, and polysiloxane elastomer). These can be used alone or in combination.

The content of the copolymer rubber according to the present invention in the rubber composition according to the present invention can be appropriately selected according to the purpose of usage. The content is preferably 70 parts by weight or more, more preferably 90 parts by weight or more, still more preferably 95 parts by weight or more, particularly preferably 100 parts by weight in 100 parts by weight of the rubber components of the rubber composition according to the present invention (i.e., an example in which the rubber components of the rubber composition according to the present invention contains substantially only the copolymer rubber according to the present invention).

Preferably, the rubber composition according to the present invention further contains a cross-linking accelerator. Although the cross-linking accelerator is not particularly limited, when the cross-linking agent is a polyamine compound or a carbonate thereof, guanidine compounds, diazabicycloalkene compounds, imidazole compounds, quaternary onium salts, tertiary phosphine compounds, aliphatic monovalent secondary amine compounds, aliphatic monovalent tertiary amine compounds, and the like can be used. Among these, guanidine compounds, diazabicycloalkene compounds, and aliphatic monovalent secondary amine compounds are preferred, guanidine compounds and diazabicycloalkene compounds are particularly preferred. These cross-linking accelerators can be used alone or in combination.

Specific examples of guanidine compounds include 1,3-di-o-tolylguanidine, 1,3-diphenylguanidine, and the like. Specific examples of diazabicycloalkene compounds include 1,8-diazabicyclo[5.4.0]undec-7-ene, 1,5-diazabicyclo[4.3.0]non-5-ene, and the like. Specific examples of imidazole compounds include 2-methylimidazole, 2-phenylimidazole, and the like. Specific examples of quaternary onium salts include tetra-n-butylammonium bromide, octadecyltri-n-butylammonium bromide, and the like. Specific examples of tertiary phosphine compounds include triphenylphosphine, tri-p-tolylphosphine, and the like.

The aliphatic monovalent secondary amine compound is a compound where two hydrogen atoms of ammonia are substituted by an aliphatic hydrocarbon group. The aliphatic hydrocarbon group substituting the hydrogen atoms is preferably a C₁ to C₃₀ aliphatic hydrocarbon group. Specific examples of the aliphatic monovalent secondary amine compounds include dimethylamine, diethylamine, dipropylamine, diallylamine, diisopropylamine, di-n-butylamine, di-t-butylamine, di-sec-butylamine, dihexylamine, diheptylamine, dioctylamine, dinonylamine, didecylamine, diundecylamine, didodecylamine, ditridecylamine, ditetradecylamine, dipentadecylamine, dicetylamine, di-2-ethylhexylamine, dioctadecylamine, and the like.

The aliphatic monovalent tertiary amine compound is a compound where three hydrogen atoms of ammonia are all substituted by an aliphatic hydrocarbon group. The aliphatic hydrocarbon group substituting the hydrogen atoms is preferably a C₁ to C₃₀ aliphatic hydrocarbon group. Specific examples of the aliphatic monovalent tertiary amine compounds include trimethylamine, triethylamine, tripropylamine, triallylamine, triisopropylamine, tri-n-butylamine, tri-t-butylamine, tri-sec-butylamine, trihexylamine, triheptylamine, trioctylamine, trinonylamine, tridecylamine, triundecylamine, tridodecylamine, and the like.

The content of the cross-linking accelerator in the rubber composition according to the present invention is preferably 0.1 to 10 parts by weight, more preferably 0.5 to 7.5 parts by weight, particularly preferably 1 to 5 parts by weight relative to 100 parts by weight of the copolymer rubber according to the present invention. When the content of the cross-linking accelerator falls within these ranges above, higher scorch stability and a higher cross-linking speed can be provided at the same time and a cross-linked rubber having further enhanced mechanical properties can be obtained.

The rubber composition according to the present invention preferably contains fillers such as a reinforcing filler and a non-reinforcing filler.

Examples of the reinforcing filler include carbon blacks such as furnace black, acetylene black, thermal black, channel black, and graphite; silicas such as wet silica, dry silica, and colloidal silica; and the like. Examples of the non-reinforcing filler include quartz powder, clay such as diatomite, zinc oxide, basic magnesium carbonate, active calcium carbonate, magnesium silicate, aluminum silicate, titanium dioxide, talc, aluminum sulfate, calcium sulfate, barium sulfate, and the like. The fillers can be used alone or in combination.

The content of the filler in the rubber composition according to the present invention is preferably 1 to 200 parts by weight, more preferably 10 to 150 parts by weight, still more preferably 20 to 100 parts by weight relative to 100 parts by weight of the rubber components including the copolymer rubber according to the present invention, although not particularly limited thereto.

The rubber composition according to the present invention may contain an antioxidant as needed. Examples of the antioxidant include, but should not be limited to, phenolic antioxidants such as sterically hindered phenolic antioxidants, semi-hindered phenolic antioxidants, less hindered phenolic antioxidants, and phenolic antioxidants having no hindered group; phosphorous acid ester antioxidants; sulfur ester antioxidants; secondary amine antioxidants such as phenyl-α-naphthylamine, phenyl-β-naphthylamine, p-(p-toluenesulfonamide)-diphenylamine, 4,4′-bis(α,α-dimethylbenzyl)diphenylamine, N,N-diphenyl-p-phenylenediamine, N-isopropyl-N′-phenyl-p-phenylenediamine, and butylaldehyde-aniline condensates; imidazole antioxidants; quinoline antioxidants; hydroquinone antioxidants; and the like. These antioxidants can be used alone or in combination.

The content of the antioxidant in the rubber composition according to the present invention is preferably 0.01 to 15 parts by weight, more preferably 0.05 to 10 parts by weight, still more preferably 0.1 to 5 parts by weight relative to 100 parts by weight of the rubber components including the copolymer rubber according to the present invention, although not particularly limited thereto.

Besides the ingredients described above, the rubber composition according to the present invention can be compounded with compounding agents usually used in the rubber processing field. Examples of such compounding agents include photostabilizers; scorch retardants; plasticizers; processing aids; tackifiers; lubricants; greases; flame retardants; antifungal agents; antistatic agents; colorants; cross-linking retarders; and the like. These compounding agents can be compounded in any amount in the range not inhibiting the object and effect of the present invention, and can be appropriately compounded in amounts according to the purpose of compounding.

The rubber composition according to the present invention can be prepared by compounding the cross-linking agent and a variety of other compounding agents used as needed with the rubber components including the copolymer rubber according to the present invention, mixing and kneading these ingredients with an open roll mill, a Banbury mixer, or a kneader, and then, further kneading the ingredients using a kneading roll.

Although the ingredients can be compounded in any order, preferred order is as follows. Ingredients which barely react or decompose by heat are sufficiently mixed, and then ingredients which readily react or decompose by heat, such as the cross-linking agent, are mixed in a short time at a temperature at which the reaction and the decomposition thereof are avoided.

### <Cross-Linked Rubber>

The cross-linked rubber according to the present invention is obtained by cross-linking the above-mentioned rubber composition according to the present invention.

The cross-linked rubber according to the present invention can be produced as follows: The rubber composition according to the present invention is formed with a forming machine which can form the rubber composition into a desired shape, such as an extruder, an injection molding machine, a press, or a roll, and the formed product is subjected to a cross-linking reaction by heating into a cross-linked rubber having a fixed shape. In this case, cross-linking may be performed after the rubber composition is preliminarily formed, or forming and cross-linking may be performed at the same time. The forming temperature is usually 10 to 140° C., preferably 25 to 120° C.

The cross-linking temperature is usually 150 to 190° C., preferably 160 to 180° C., and the cross-linking time is usually 2 to 60 minutes, preferably 3 to 40 minutes. The heating method can be appropriately selected from methods used in cross-linking of rubber, such as press heating, steam heating, oven heating, and hot air heating.

In the method of producing the cross-linked rubber according to the present invention, it is not always necessary to perform secondary cross-linking, and secondary cross-linking may be performed. The secondary cross-linking is usually performed under a heated air environment at 130 to 220° C. for 1 to 48 hours.

From the viewpoint of productivity, energy saving, and carbon neutrality, the cross-linked rubber according to the present invention is preferably a primarily cross-linked product of the rubber composition according to the present invention. For example, the cross-linked rubber according to the present invention is preferably a primarily cross-linked product obtained by cross-linking the rubber composition according to the present invention by heating at a temperature of 150° C. to 190° C. for 2 to 60 minutes.

The cross-linked rubber according to the present invention is suitably used as sealing materials such as O-rings, packings, diaphragms, oil seals, shaft seals, bearing sheaths, mechanical seals, wellhead seals, seals for electrical and electronic devices, and seals for air compressors; a variety of gaskets such as cylinder head gaskets attached to a connection between a cylinder block and a cylinder head, rocker cover gaskets attached to a connection between a rocker cover and a cylinder head, oil pan gaskets attached to a connection between an oil pan and a cylinder head or a transmission case, gaskets for fuel cell separators attached between a pair of housings to sandwich a unit cell including a positive electrode, an electrolyte plate, and a negative electrode, and a gasket for top covers for hard disk drives; buffer materials; vibration insulators; coating materials for electric wires; industrial belts; tubing materials and hose materials; belt materials; boot materials; sheets; and the like.

The cross-linked rubber according to the present invention is also suitably used as extrusion molded products and cross-linked products used in automobile applications, for example, as a variety of materials for houses including fuel oil hoses for fuel tanks such as fuel hoses, filler neck hoses, vent hoses, vapor hoses, and oil hoses, air hoses such as turbo air hoses and transmission control hoses, radiator hoses, heater hoses, brake hoses, and air conditioner hoses.

### EXAMPLES

Hereinafter, the present invention will be specifically described by way of Examples, but the present invention will not be limited to these Examples. Note that the term “part(s)” is weight-based unless otherwise specified. A variety of physical properties were measured as follows.

### <Monomer Composition of Copolymer Rubber>

The monomer composition of each of copolymer rubbers was calculated from the amounts of the monomers used in the polymerization reaction and the polymerization conversion ratio. Specifically, in the emulsion polymerization reactions in Examples and Comparative Examples, unreacted monomers were not confirmed, and the polymerization conversion ratio was substantially 100%. Thus, the amounts of the monomers used in the polymerization reaction were considered as the contents of the monomer units contained in the copolymer rubber.

### <Glass Transition Temperature>

Using a differential scanning calorimeter (differential scanning calorimetry, DSC), each of copolymer rubbers was measured from −80° C. to 30° C. at a heating rate of 10° C./min, and the glass transition temperature was determined from the peak tops in a differential curve.

### <Polymer Mooney Viscosity>

Each of copolymer rubbers was measured for polymer Mooney viscosity (ML1+4,100° C.) in accordance with JIS K6300-1:2013.

### <Scorch Stability Test>

Each of rubber compositions was measured for Mooney scorching under a measurement condition at 125° C. in accordance with JIS K6300 to determine the minimum value (Vmin) of the Mooney viscosity. The time at which the Mooney viscosity increased by 5 points from the minimum value (Vmin) of the Mooney viscosity was determined as Mooney scorch time (t5). A greater value of the Mooney scorch time (t5) can be determined as higher scorch stability.

### <Cross-Linkability Test>

Using a rubber vulcanization tester (trade name “Moving Die Rheometer MDR”, available from Alpha Technologies, Inc.), rubber compositions were subjected to a cross-linkability test at 170° C. for 20 minutes in accordance with JIS K6300-2. From the results in the cross-linkability test, the minimum value (ML) of the torque (unit: dN·m), the maximum value (MH) of the torque (unit: dN·m), and T90 (unit: min) were determined. T90 indicates the time taken for the torque to increase 90% from the minimum torque ML where “maximum torque MH—minimum torque ML” was regarded as 100%, and a smaller value of T90 can be determined as a higher cross-linking speed.

### <Normal-State Physical Properties of Cross-Linked Rubber (Primarily Cross-Linked Product)>

In accordance with JIS K6251, test pieces were cut from sheet-shaped cross-linked rubbers (primarily cross-linked products), and were measured for tensile strength, elongation at break, and stress at 100% elongation. In accordance with JIS K6253-3, the sheet-shaped cross-linked rubbers (primarily cross-linked products) were measured for hardness using a durometer hardness tester (type A).

### <Air Oven Heat Aging Test in Cross-Linked Rubber (Primarily Cross-Linked Product)>

Sheet-shaped acrylic cross-linked rubbers (primarily cross-linked products) were subjected to an air oven heat aging test under an environment at 175° C. for 72 hours in accordance with JIS K6257. In the next step, test pieces were cut out from the acrylic cross-linked rubbers after the air oven heat aging test in accordance with JIS K6251, and the obtained test pieces were measured for tensile strength, elongation at break, and stress at 100% elongation. When the measured values of these properties before the air oven heat aging test were regarded as reference values (100%), the proportions (%) of increases in the measured values thereof after the air oven heat aging test were calculated.

### <Compression Set of Cross-Linked Rubber (Primarily Cross-Linked Product)>

Using cylindrical cross-linked rubbers (primarily cross-linked products), the compression set was determined in accordance with JIS K6262 under a compression condition at a compression ratio of 25% and 175° C. for 72 hours.

### <Butenedioic Acid Diester Structure-Containing Monomer>

In Examples, butenedioic acid diester structure-containing monomers (a) to (e) represented by Formulae (a) to (e) below were used. The butenedioic acid diester structure-containing monomers (a) to (e) were produced according to Production Examples below.

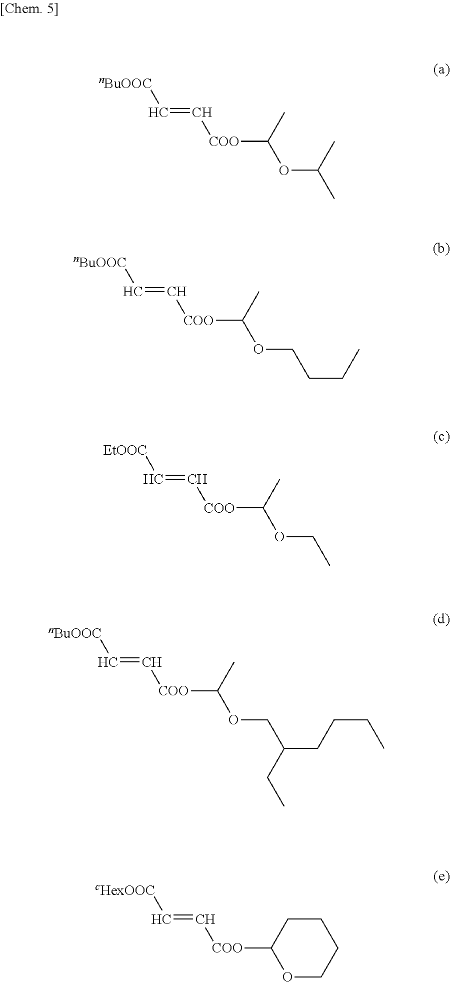

### Production Example 1

### (Production of Butenedioic Acid Diester Structure-Containing Monomer (a))

Under a nitrogen atmosphere, 61 mL of acetone (product from FUJIFILM Wako Pure Chemical Corporation), 69 g (400 mmol) of mono-n-butyl fumarate (product from FUJIFILM Wako Pure Chemical Corporation), and 66 mL (600 mmol) of isopropyl vinyl ether (product from FUJIFILM Wako Pure Chemical Corporation) were added to a three-necked flask having a volume of 500 ml, and then, 0.45 mL (1.6 mmol) of 2-ethylhexyl phosphate (product from Tokyo Chemical Industry Co., Ltd.) was added. These were stirred at 50° C. for 6 hours, followed by cooling to room temperature. Subsequently, the product was extracted with 250 mL of a 1M potassium hydroxide aqueous solution (product from FUJIFILM Wako Pure Chemical Corporation) three times, and was washed with water. An organic phase was separated, anhydrous magnesium sulfate (product FUJIFILM Wako Pure Chemical Corporation) was added to dry off a residual water content, and the solvent was removed under reduced pressure, thereby giving 91 g of a colorless transparent liquid of a butenedioic acid diester structure-containing monomer (a).

### Production Example 2

### (Production of Butenedioic Acid Diester Structure-Containing Monomer (b))

Under a nitrogen atmosphere, 61 mL of acetone (product from FUJIFILM Wako Pure Chemical Corporation), 69 g (400 mmol) of mono-n-butyl fumarate (product from FUJIFILM Wako Pure Chemical Corporation), and 77 mL (600 mmol) of n-butyl vinyl ether (product from FUJIFILM Wako Pure Chemical Corporation) were added to a three-necked flask having a volume of 500 ml, and then, 0.45 mL (1.6 mmol) of 2-ethylhexyl phosphate (product from Tokyo Chemical Industry Co., Ltd.) was added. These were stirred at 50° C. for 6 hours, followed by cooling to room temperature. Subsequently, the product was extracted with 250 mL of a 1M potassium hydroxide aqueous solution (product from FUJIFILM Wako Pure Chemical Corporation) three times, and was washed with water. An organic phase was separated, anhydrous magnesium sulfate (product FUJIFILM Wako Pure Chemical Corporation) was added to dry off a residual water content, and the solvent was removed under reduced pressure, thereby giving 105 g of a colorless transparent liquid of a butenedioic acid diester structure-containing monomer (b).

### Production Example 3

### (Production of Butenedioic Acid Diester Structure-Containing Monomer (c))

Under a nitrogen atmosphere, 61 mL of acetone (product from FUJIFILM Wako Pure Chemical Corporation), 69 g (400 mmol) of mono-n-ethyl fumarate (product from FUJIFILM Wako Pure Chemical Corporation), and 58 mL (600 mmol) of ethyl vinyl ether (product from FUJIFILM Wako Pure Chemical Corporation) were added to a three-necked flask having a volume of 500 ml, and then, 0.45 mL (1.6 mmol) of 2-ethylhexyl phosphate (product from Tokyo Chemical Industry Co., Ltd.) was added. These were stirred at 50° C. for 6 hours, followed by cooling to room temperature. Subsequently, the product was extracted with 250 mL of a 1M potassium hydroxide aqueous solution (product from FUJIFILM Wako Pure Chemical Corporation) three times, and was washed with water. An organic phase was separated, anhydrous magnesium sulfate (product FUJIFILM Wako Pure Chemical Corporation) was added to dry off a residual water content, and the solvent was removed under reduced pressure, thereby giving 87 g of a colorless transparent liquid of a butenedioic acid diester structure-containing monomer (c).

### Production Example 4

### (Production of Butenedioic Acid Diester Structure-Containing Monomer (d))

Under a nitrogen atmosphere, 41 mL of acetone (product from FUJIFILM Wako Pure Chemical Corporation), 46 g (270 mmol) of mono-n-butyl fumarate (product from FUJIFILM Wako Pure Chemical Corporation), and 43 mL (227 mmol) of 2-ethylhexyl vinyl ether (product from FUJIFILM Wako Pure Chemical Corporation) were added to a three-necked flask having a volume of 500 ml, and then, 0.45 mL (1.6 mmol) of 2-ethylhexyl phosphate (product from Tokyo Chemical Industry Co., Ltd.) was added. These were stirred at 50° C. for 6 hours, followed by cooling to room temperature. Subsequently, the product was extracted with 250 mL of a 1M potassium hydroxide aqueous solution (product from FUJIFILM Wako Pure Chemical Corporation) three times, and was washed with water. An organic phase was separated, anhydrous magnesium sulfate (product FUJIFILM Wako Pure Chemical Corporation) was added to dry off a residual water content, and the solvent was removed under reduced pressure, thereby giving 64 g of a colorless transparent liquid of a butenedioic acid diester structure-containing monomer (d).

### Production Example 5

### (Production of Butenedioic Acid Diester Structure-Containing Monomer (e))

Under a nitrogen atmosphere, 61 mL of acetone (product from FUJIFILM Wako Pure Chemical Corporation), 79 g (400 mmol) of monocyclohexyl fumarate (product from ChemBridge Corporation), and 55 mL (600 mmol) of 3,4-dihydro-2H-pyran (product from FUJIFILM Wako Pure Chemical Corporation) were added to a three-necked flask having a volume of 500 ml, and then, 0.45 mL (1.6 mmol) of 2-ethylhexyl phosphate (product from Tokyo Chemical Industry Co., Ltd.) was added. There were stirred at 50° C. for 6 hours, followed by cooling to room temperature. Subsequently, the product was extracted with 250 mL of a 1M potassium hydroxide aqueous solution (product from FUJIFILM Wako Pure Chemical Corporation) three times, and was washed with water. An organic phase was separated, anhydrous magnesium sulfate (product FUJIFILM Wako Pure Chemical Corporation) was added to dry off a residual water content, and the solvent was removed under reduced pressure, thereby giving 75 g of a colorless transparent liquid of a butenedioic acid diester structure-containing monomer (e).

### Example 1

### (Production of Copolymer Rubber (A-1))

46.294 Parts of deionized water, 60.0 parts of ethyl acrylate, 38.1 parts of n-butyl acrylate, and 1.9 parts of the butenedioic acid diester structure-containing monomer (a) represented by Formula (a) above as monomers, and 1.8 parts of sodium tridecyloxyhexa(oxyethylene)phosphate as an anionic emulsifier were placed into a mixing vessel equipped with a homomixer, and were stirred to prepare a monomer emulsion solution.

In the next step, 170.853 parts of pure water and 2.962 parts of the monomer emulsion solution prepared above were placed into a polymerization reaction tank equipped with a thermometer and a stirrer, and were cooled to 12° C. under a nitrogen stream. Then, 145.132 parts of the monomer emulsion solution obtained above, 0.00033 parts of ferrous sulfate (reductant), 0.264 parts of sodium ascorbate (reductant), and 7.72 parts (0.22 parts in terms of the amount of potassium persulfate) of a 2.85% by weight potassium persulfate aqueous solution (polymerization initiator) were continuously added dropwise to the polymerization reaction tank over 3 hours while the temperature was being kept at 12° C. Subsequently, while the inner temperature of the polymerization reaction tank was being kept at 23° C., the reaction was continued for 1 hour. After it was verified that the polymerization conversion ratio reached substantially 100%, hydroquinone as a polymerization terminator was added to terminate the polymerization reaction, thereby giving a polymer emulsion.

In the next step, 60 parts of a 30% by weight magnesium sulfate aqueous solution adjusted to 85° C. was placed into a solidification tank equipped with a thermometer and a stirrer, and was heated to 85° C. In this state, stirring was performed with a stirring blade. Under stirring, 100 parts of the polymer emulsion prepared above was continuously added to the magnesium sulfate aqueous solution to solidify the polymer. The polymer was filtered out, giving hydrous crumbs.

In the next step, 388 parts of industrial water was added relative to 100 parts of the solid content of the hydrous crumbs obtained above, and was stirred in the solidification tank at room temperature for 5 minutes. Thereafter, the water was discharged from the solidification tank. Thus, the hydrous crumbs were washed with water. Then, the hydrous crumbs after the washing with water were dried with a hot air dryer at 110° C. for 1 hour, giving a copolymer rubber (A-1) in a solid form with a recovery rate of 100%. The glass transition temperature and polymer Mooney viscosity of the resulting copolymer rubber (A-1) were measured by the methods described above. The results are shown in Table 2.

### Preparation of Rubber Composition

Using a kneader, 60 parts of carbon black (trade name “SEAST SO”, available from Tokai Carbon Co., Ltd.), 2 parts of stearic acid, 1 part of ester wax (trade name “Gregg G-8205”, available from DIC Corporation), and 2 parts of 4,4′-bis(α,α-dimethylbenzyl)diphenylamine (trade name “NOCRAC CD”, available from Ouchi Shinko Chemical Industrial Co., Ltd., antioxidant) were added to 100 parts of the copolymer rubber (A-1), and these were mixed at 50° C. for 7 minutes. The resulting mixture was transferred to a roll at 50° C., and 0.5 parts of hexamethylenediamine carbamate (trade name “Diak No. 1”, available from Dupont Dow Elastomers LLC, cross-linking agent) and 2 parts of 1,3-di-o-tolylguanidine (trade name “NOCCELER DT”, available from Ouchi Shinko Chemical Industrial Co., Ltd., cross-linking accelerator) were compounded. These were kneaded with the roll, giving a rubber composition. Using the resulting rubber composition, the scorch stability test and the cross-linkability test were performed by the above-mentioned methods. The results are shown in Table 2.

### (Production of Cross-Linked Rubber)

The rubber composition was formed and cross-linked at 170° C. for 20 minutes at 10 MPa with a press, giving a sheet-shaped acrylic cross-linked rubber (primarily cross-linked product) having a size of 15 cm×15 cm×2 mm. Using the resulting sheet-shaped cross-linked rubber (primarily cross-linked product), normal-state physical properties were measured by the above-mentioned methods, and the air oven heat aging test was performed. The results are shown in Table 2. The rubber composition was formed and cross-linked at 170° C. for 20 minutes at 10 MPa with a press to prepare a cylindrical cross-linked rubber (primarily cross-linked product) having a diameter of 29 mm and a thickness of 12.5 mm, and the compression set was measured. The results are shown in Table 2.

### Examples 2 to 7, Comparative Examples 1 to 2

### (Production of Copolymer Rubber (A-1))

Copolymer rubbers (A-2) to (A-9) were in the same manner as in Example 1 except that the types and amounts of the monomers were varied as shown in Table 1. Rubber compositions and cross-linked rubbers were obtained in the same manner as in Example 1 except that the resulting copolymer rubbers (A-2) to (A-9) were used, and were evaluated as in Example 1. The results are shown in Table 2.

TABLE 1

| | Example | | | | | | | Comp. Ex. | |
|---|---|---|---|---|---|---|---|---|---|
| | 1 | 2 | 3 | 4 | 5 | 6 | 7 | 1 | 2 |
| Monomer composition of copolymer rubber | (A-1) | (A-2) | (A-3) | (A-4) | (A-5) | (A-6) | (A-7) | (A-8) | (A-9) |
| (proportions of monomers used in polymerization) | | | | | | | | | |
| Ethyl acrylate unit (wt %) | 60.0 | 60.0 | 60.0 | 60.0 | 60.0 | 54.0 | 7.8 | 60.0 | 60.0 |
| n-Butyl acrylate unit (wt %) | 38.1 | 37.8 | 38.0 | 37.3 | 38.0 | 42.0 | 65.0 | 38.5 | 38.7 |
| 2-Methoxyethyl acrylate unit (wt %) | — | — | — | — | — | — | 25 | — | — |
| Unit of butenedioic acid diester | 1.9 | — | — | — | — | — | — | | — |
| structure-containing monomer (a) (wt %) | | | | | | | | | |
| Unit of butenedioic acid diester | — | 2.2 | — | — | — | 4.0 | 2.2 | — | — |
| structure-containing monomer (b) (wt %) | | | | | | | | | |
| Unit of butenedioic acid diester | — | — | 2.0 | — | — | — | — | — | — |
| structure-containing monomer (c) (wt %) | | | | | | | | | |
| Unit of butenedioic acid diester | — | — | — | 2.7 | — | — | — | — | — |
| structure-containing monomer (d) (wt %) | | | | | | | | | |
| Unit of butenedioic acid diester | — | — | — | — | 2.0 | — | — | — | — |
| structure-containing monomer (e) (wt %) | | | | | | | | | |
| Monobutyl fumarate unit (wt %) | — | — | — | — | — | — | — | 1.5 | — |
| Monocyclohexyl fumarate unit (wt %) | — | — | — | — | — | — | — | — | 1.3 |
| Rubber composition | | | | | | | | | |
| Copolymer rubber (parts) | 100 | 100 | 100 | 100 | 100 | 100 | 100 | 100 | 100 |
| Carbon black (parts) | 60 | 60 | 60 | 60 | 60 | 60 | 60 | 60 | 60 |
| Stearic acid (parts) | 2 | 2 | 2 | 2 | 2 | 2 | 2 | 2 | 2 |
| Ester wax (parts) | 1 | 1 | 1 | 1 | 1 | 1 | 1 | 1 | 1 |
| 4,4′-Di-(α,α-dimethylbenzyl)diphenylamine (parts) | 2 | 2 | 2 | 2 | 2 | 2 | 2 | 2 | 2 |
| Hexamethylenediamine carbamate (parts) | 0.5 | 0.5 | 0.5 | 0.5 | 0.5 | 0.5 | 0.5 | 0.5 | 0.5 |
| 1,3-Di-o-tolylguanidine (parts) | 2 | 2 | 2 | 2 | 2 | 2 | 2 | 2 | 2 |

TABLE 2

| | Example | | | | | | | Comp. Ex. | |
|---|---|---|---|---|---|---|---|---|---|
| | 1 | 2 | 3 | 4 | 5 | 6 | 7 | 1 | 2 |
| Copolymer rubber | (A-1) | (A-2) | (A-3) | (A-4) | (A-5) | (A-6) | (A-7) | (A-8) | (A-9) |
| Glass transition temperature (° C.) | −27 | −27 | −27 | −27 | −27 | −29 | −40 | −27 | −27 |
| Polymer Mooney viscosity (ML1 + 4, 100° C.) | 38 | 37 | 31 | 24 | 28 | 21 | 28 | 41 | 43 |

Rubber composition
Scorch stability test (125° C.)

| | | | | | | | | | |
|---|---|---|---|---|---|---|---|---|---|
| Minimum value (Vmin) of Mooney viscosity | 46 | 45 | 41 | 35 | 38 | 33 | 37 | 52 | 53 |
| Mooney scorch time (t5) (min) | 9.1 | 11.8 | 12.1 | 14.1 | 14.9 | 10.2 | 10.5 | 4.7 | 4.9 |

Cross-linkability test (170° C., 20 min)

| | | | | | | | | | |
|---|---|---|---|---|---|---|---|---|---|
| Torque minimum value (ML) (dN · m) | 2.0 | 2.1 | 1.8 | 1.6 | 1.8 | 1.5 | 1.8 | 2.1 | 2.2 |
| Torque maximum value (MH) (dN · m) | 7.6 | 7.6 | 7.1 | 6.6 | 8.0 | 7.9 | 7.0 | 10.3 | 9.4 |
| T90 (min) | 3.0 | 3.8 | 4.9 | 5.7 | 6.4 | 3.2 | 3.5 | 10.2 | 9.2 |

Cross-linked rubber
Normal-state physical properties of cross-linked rubber (primarily cross-linked product)

| | | | | | | | | | |
|---|---|---|---|---|---|---|---|---|---|
| Tensile strength (MPa) | 11.7 | 11.6 | 11.2 | 10.3 | 10.3 | 11.0 | 9.2 | 10.3 | 10.1 |
| Elongation at break (%) | 320 | 330 | 340 | 330 | 310 | 290 | 250 | 290 | 330 |
| Stress at 100% elongation (MPa) | 2.5 | 2.4 | 2.4 | 2.1 | 2.8 | 2.7 | 2.9 | 3.4 | 2.8 |
| Hardness (peak) (Duro A) | 58 | 59 | 60 | 58 | 64 | 58 | 58 | 69 | 68 |

Air oven heat aging test in cross-linked rubber (primarily cross-linked product)

| | | | | | | | | | |
|---|---|---|---|---|---|---|---|---|---|
| Proportion of increase in tensile strength (%) | −1 | 2 | 0 | 5 | 6 | 1 | 1 | 4 | 2 |
| Proportion of increase in elongation at break (%) | −14 | −14 | −15 | −16 | −10 | −10 | −17 | −19 | −17 |
| Proportion of increase in stress at 100% elongation (%) | 20 | 16 | 18 | 26 | 18 | 13 | 16 | 16 | 21 |

Compression set of cross-linked rubber (primarly cross-linked product)

| | | | | | | | | | |
|---|---|---|---|---|---|---|---|---|---|
| Compression set (175° C. × 72 h) (%) | 33 | 30 | 34 | 38 | 39 | 28 | 34 | 36 | 46 |

As shown in Table 1, the copolymer rubbers obtained by copolymerizing the butenedioic acid diester structure-containing monomer represented by General Formula (1) and the radical polymerizable monomer had a long scorch time (t5) and favorable scorch stability, and gave cross-linked rubbers having sufficient mechanical properties without secondary cross-linking (Examples 1 to 7).

In contrast, the copolymer rubbers not containing the unit derived from the butenedioic acid diester structure-containing monomer represented by General Formula (1) had a short scorch time (t5) and poor scorch stability (Comparative Examples 1 to 2)

1. A copolymer rubber obtained by copolymerizing a butenedioic acid diester structure-containing monomer represented by General Formula (1) below and a radical polymerizable monomer: 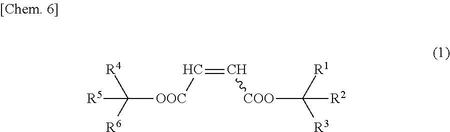
(in General Formula (1), R¹ is a C₁ to C₄ alkyl group; R² is a group represented by R⁷ or OR⁸; R⁷ is an optionally substituted C₁ to C₈ alkyl group; R⁸ is an optionally substituted C₁ to C₈ alkyl group or an optionally substituted polyalkylene glycol group; R³, R⁴, and R⁶ each independently represent a hydrogen atom or a C₁ to C₄ alkyl group; R⁵ is a hydrogen atom or a group represented by R⁷ or OR⁸; when R³ is a hydrogen atom, R² is a group represented by OR⁸;
R¹ and R² may be bonded to each other to form a ring; and R⁴ and R⁵ may be bonded to each other to form a ring).

2. The copolymer rubber according to claim 1, wherein the content of a unit of the butenedioic acid diester structure-containing monomer represented by General Formula (1) is 0.1 to 10% by weight.

3. The copolymer rubber according to claim 1, wherein as the radical polymerizable monomer, the copolymer rubber contains at least one selected from the group consisting of (meth)acrylic acid ester monomers, (meth)acrylonitrile monomers, aromatic vinyl monomers, conjugated diene monomers, (meth)acrylamide monomers, vinyl acetate monomer, and ethylene monomer.

4. The copolymer rubber according to claim 1, wherein the copolymer rubber has a glass transition temperature of 0° C. or lower.

5. The copolymer rubber according to claim 1, wherein the copolymer rubber contains an (meth)acrylic acid ester monomer as the radical polymerizable monomer.

6. The copolymer rubber according to claim 1, wherein the copolymer rubber has a Mooney viscosity (ML1+4, 100° C.) of 10 to 150.

7. The copolymer rubber according to claim 1, wherein the butenedioic acid diester structure-containing monomer represented by General Formula (1) is a butenedioic acid diester structure-containing monomer represented by General Formula (2) or (3) below: 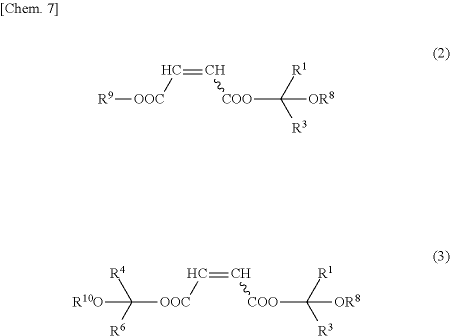
(in General Formulae (2) and (3), R¹, R³, R⁴, R⁶, and R⁸ are each independently the same as those defined in General Formula (1); R⁹ is an optionally substituted C₁ to C₁₇ alkyl group;
R¹⁰ is an optionally substituted C₁ to C₈ alkyl group or an optionally substituted polyalkylene glycol group; R¹ and R⁸ may be bonded to each other to form a ring; and R⁴ and R¹⁰ may be bonded to each other to form a ring).

8. A rubber composition comprising the copolymer rubber according to claim 1 and a cross-linking agent.

9. The rubber composition according to claim 8, further comprising a cross-linking accelerator.

10. The rubber composition according to claim 8, further comprising a filler.

11. A cross-linked rubber obtained by cross-linking the rubber composition according to claim 8.

12. The cross-linked rubber according to claim 11, wherein the cross-linked rubber is a hose material, a sealing material, a tubing material, a belt material, or a boot material.
